(19) United States
(12) Patent Application Publication
(10) Pub. No.: US 2011/0208341 A1
(43) Pub. Date: Aug. 25, 2011

(54) METHOD AND SYSTEM FOR CONTROLLING AN INDUSTRIAL PROCESS

(75) Inventors: Konrad STADLER, Niederweningen (CH); Eduardo Gallestey Alvarez, Mellingen (CH); Jan Poland, Nussbaumen (CH)

(73) Assignee: ABB RESEARCH LTD., Zurich (CH)

(21) Appl. No.: 13/051,249

(22) Filed: Mar. 18, 2011

Related U.S. Application Data
(63) Continuation of application No. PCT/EP2009/062175, filed on Sep. 21, 2009.

(30) Foreign Application Priority Data
Sep. 23, 2008 (EP) 08164844.6

(51) Int. Cl. G06F 19/00

(52) U.S. Cl. 700/104

(57) ABSTRACT

A control system for controlling an industrial process includes an indicator generator configured to determine at least one fuzzy logic based indicator from measured process variables. The control system also includes a state estimator configured to determine estimated physical process states based on the fuzzy indicator. For controlling the industrial process, the process controller is configured to calculate manipulated variables based on (i) defined set-points and (ii) a physical model of the process using the estimated physical process states. Combining a fuzzy logic indicator with a model based process controller provides robust indicators of the process states for controlling an industrial process in a real plant situation in which measured process variables may possibly contradict each other.

### RELATED APPLICATIONS

This application claims priority as a continuation application under 35 U.S.C. §120 to PCT/EP2009/062175, which was filed as an International Application on Sep. 21, 2009 designating the U.S., and which claims priority to European Application 08164844.6 filed in Europe on Sep. 23, 2008. The entire contents of these applications are hereby incorporated by reference in their entireties.

### FIELD

The present disclosure relates to a system and a control method for controlling an industrial process. More particularly, the present disclosure relates to a system and a control method for controlling an industrial process, such as operating a rotary kiln in a cement production process, by calculating manipulated variables based on defined set-points and a fuzzy logic indicator determined from measured process variables.

### BACKGROUND INFORMATION

In advanced process control for industrial processes, many different system configurations with respect to the control algorithm are known. However, as illustrated in FIG. 3, according to user specifications (set-points, r), all systems generate set-points for a set of actuators (manipulated variables, u), taking into account measurements taken from a set of sensors (process variables, y). However, not all desired process variables y can be measured. As a result, indicator generators 33 are used to determine process indicators z in approximation of these missing measurements. As illustrated schematically in FIG. 3, the indicators z are determined based on one or more of the process variables y₂ and/or manipulated variables u₂.

For example, in the cement production process, the raw components and the raw mixture are transported from the feeders to a kiln, possibly involving additional crushers, feeders that provide additional additives to the raw mixture, transport belts, storage facilities and the like. As illustrated in FIG. 1, the kiln 1 is arranged with a slope and mounted such that it can be rotated about its central longitudinal axis. The raw mixture (meal) 11 is introduced at the top (feed or back end) 12 of the kiln 1 and transported under the force of gravity down the length of the kiln 1 to an exit opening (discharge or front end) 13 at the bottom. The kiln 1 operates at temperatures in the order of 1,000 degrees Celsius. As the raw mixture 11 passes through the kiln 1, the raw mixture 11 is calcined (reduced, in chemical terms). Water and carbon dioxide are driven off, chemical reactions take place between the components of the raw mixture 11, and the components of the raw mixture 11 fuse to form what is known as clinker 14. In the course of these reactions, new compounds are formed. The fusion temperature depends on the chemical composition of the feed materials and the type and amount of fluxes that are present in the mixture. The principal fluxes are alumina (Al₂O₃) and iron oxide (Fe₂O₃), which enable the chemical reactions to occur at relatively lower temperatures.

The environmental conditions of the clinker production (up to 2500° C., dusty, rotating) do not make it possible for direct measurement of the temperature profile 10 along the length of a rotary kiln 1. Consequently, burning zone temperature Y_{BZT} is used as the indicator in known systems and by the operators of a rotary cement kiln 1. The sintering condition or burning zone temperature Y_{BZT} is usually related to one or a combination of several of the following measurements:
The torque (or power) required to rotate the kiln 1 (Y_{Torque});
NOₓ measurements in the exhaust gas (Y_{NOx}); and
Temperature readings based on a pyrometer located at the exit opening (discharge or front end) 13 of the kiln 1 (Y_{Pyro}).

As the hot meal becomes stickier at higher temperatures, the torque needed to rotate increases because more and more material is dragged up the side of the kiln. The temperature of the gas can be related to the NO levels in the exhaust gas. All three measurements are unreliable, however. For example, the varying dust condition will significantly influence the pyrometer readings, as the pyrometer may be directed at “shadows” producing false readings. Nevertheless, the aggregation of the three measurements, as defined in equation (1), can provide a reasonably reliable determination of the burning zone temperature Y_{BZT}.

Y_{BZT}=ƒ(Y_{Torque}, Y_{NOx}, Y_{Pyro}) (1)

where ƒ is a description on how Y_{YBZT} relates to the sensor measurements. The function ƒ can be described by a fuzzy logic system (often called expert system) performed by an indicator generator. This indicator is thus a fuzzy logic based indicator, for example an integer value on the scale [−3, +3] corresponding to an indication of [cold . . . hot], i.e. a fuzzy indicator of the aggregated burning zone temperature, but not an actual physical temperature value (in ° C. or ° F.).

While the aggregation of the three measurements provides the burning zone temperature as a reasonably reliable indicator of the burning zone temperature, it does not provide the temperature profile along the whole length of the rotary kiln. However, knowledge of the temperature profile would make possible better predictions of the process, leading to an improved process control.

In another example, a wet grinding process may require grinding circuits with different configurations depending on the ore characteristics, the design plant capacity, etc. As illustrated in FIG. 2, the grinding circuit 2 will can include several mills (rod, ball, SAG, AG) 21, 22 in series and/or parallel with a number of classifiers (hydrocyclones) 23 and sumps 24 at appropriate locations. In an known arrangement, one of the streams leaving the classifier 23 is conduced back through a pump 25 either to a sump 24 or to another mill 21, 22 for further processing, while the other stream is eliminated from the circuit 2. One classifier will have the task of selecting the final product. Water 26 is normally added at the sumps 24, with fresh feed 20 entering the system. Grinding media is introduced in the system continuously based on estimations of their load in the mills 21, 22. The goal of the grinding section is to reduce the ore particle size to levels adequate for processing in the flotation stage. Measurable process variables may include mill sound level, mill bearing pressure, mill power draw, slurry density, and flows and pressures at critical places. Controllable variables to be manipulated include fresh feed rate, process water flow (pump rate), and rotational speed of the mill(s). The process targets include particle size specification, circulating load target, and bearing pressure limits. Thus, based on the measurable process variables and/or controllable variables, one or more indicators need to be determined for controlling the grinding process. It is desired to be able to have a constant product rate within the quality specifications. It is also desired to be able to execute this process step with lowest possible energy and grinding media consumption.

### SUMMARY

An exemplary embodiment of the present disclosure provides a control method for controlling an industrial process. The exemplary method includes measuring a plurality of process variables, and determining at least one fuzzy logic based indicator from the measured process variables. The exemplary method also includes calculating, for controlling the process, manipulated variables based on defined set-points and the determined indicator. In addition, the exemplary method includes determining estimated process states based on the indicator, and calculating, by a controller, the manipulated variables based on a model of the process using the estimated process states.

An exemplary embodiment of the present disclosure provides a control system for controlling an industrial process. The exemplary system includes sensors for measuring a plurality of process variables, and an indicator generator configured to determine at least one fuzzy logic based indicator from the measured process variables. The exemplary system also includes a process controller configured to calculate manipulated variables based on defined set-points and the determined indicator. In addition, the exemplary system includes an estimator configured to determine estimated process states based on the indicator. The process controller is configured to calculate the manipulated variables based on a model of the process using the estimated process states.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic illustration of a conventional rotary kiln and a graph of a temperature profile along the kiln;

FIG. 2 shows a block diagram illustrating a conventional grinding circuit for executing a wet grinding process;

FIG. 3 shows a block diagram illustrating a conventional control system for controlling an industrial process, in which the control system includes an indicator generator linked to a process controller; and

FIG. 4 shows a block diagram illustrating an example of a control system according to an exemplary embodiment of the present disclosure for controlling an industrial process, in which the exemplary control system includes a state estimator which links the indicator generator to a model based process controller.

### DETAILED DESCRIPTION

Exemplary embodiments of the present disclosure provide a control system and a control method for controlling an industrial process in a real plant situation in which the available signals representing measurements of process variables may possibly contradict each other, rendering them useless in a conventional model based control system. For instance, exemplary embodiments of the present disclosure provide a control system and a control method which provide robust (reliable) indicators of the state of a cement rotary kiln that can be used to generate a temperature profile of the rotary kiln. Other exemplary embodiments of the present disclosure provide a control system and a control method which provide a robust indicator of a mill state of a grinding system.

For controlling an industrial process, a plurality of process variables are measured, at least one fuzzy logic based indicator (may be abbreviated as: fuzzy logic indicator) is determined from the measured process variables, and, for controlling the process, manipulated variables are calculated based on defined set-points and the fuzzy logic indicator. For example, the fuzzy logic indicator is determined using a neural network or a statistical learning method.

According to an exemplary embodiment of the present disclosure, estimated process states are determined based on the fuzzy logic indicator, and the manipulated variables are calculated by a controller based on a model of the process using the estimated process states. For example, estimated physical process states are determined based on the fuzzy logic indicator, and the manipulated variables are calculated by a controller based on a physical model of the process using the estimated physical process states. For example, the controller can be a Model Predictive Controller (MPC). For example, the estimated process states can be determined by one of a Kalman filter, a state observer, and a moving horizon estimation method.

For example, the industrial process can relate to operating a rotary kiln, e.g. for a cement production process. Correspondingly, measuring the process variables includes measuring the torque required for rotating the kiln, measuring the NO level in the exhaust gas, and taking pyrometer readings at an exit opening of the kiln. A burning zone temperature can be determined as a fuzzy logic indicator based on the torque, the NO level, and the pyrometer readings. A temperature profile along a longitudinal axis of the kiln can be determined as the estimated process state based on the burning zone temperature, and the manipulated variables can then be calculated based on the temperature profile.

In accordance with an exemplary embodiment, the fuzzy logic indicator can be based on the measured process variables and on one or more of the manipulated variables.

In accordance with an exemplary embodiment, the estimated process states can be determined based on the fuzzy logic indicator, one or more of the process variables, and/or one or more of the manipulated variables.

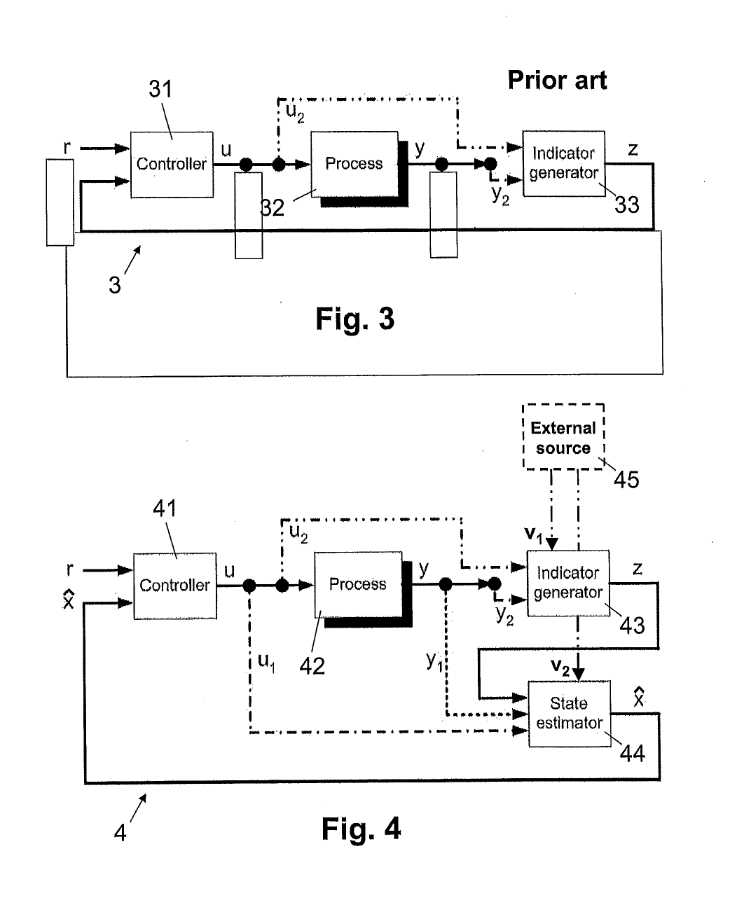

FIG. 3 shows a known control system 3 that includes a process controller 31 for controlling an industrial process 32 based on user defined set- points r.

The control system 3 further includes an indicator generator 33, which includes a fuzzy logic or expert system. The indicator generator 33 is configured to generate a fuzzy logic indicator z based on a set y₂ of measured process variables y, and/or based on a set u₂ of the manipulated variables u. The manipulated variables u are generated by the process controller 31 for controlling the industrial process 32. The fuzzy logic indicator z is fed back to the process controller 31, which is accordingly configured as a fuzzy logic or expert system based controller to derive the set-points of the manipulated variables u based on the fuzzy logic indicator z.

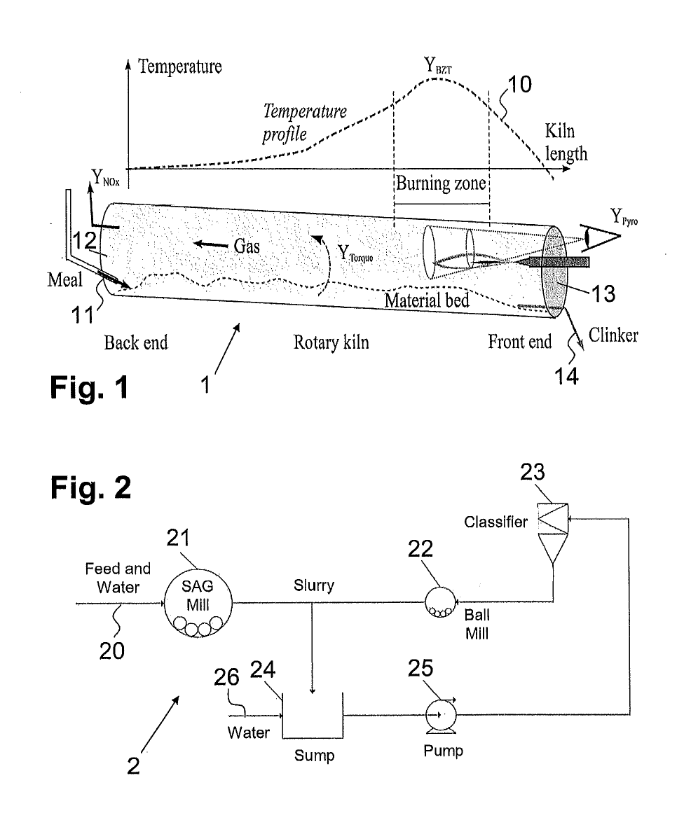

For example, in a cement production process, such as in operating a rotary kiln 1 in a cement production process, the fuzzy indicator z indicates the aggregated burning zone temperature Y_{BZT} of the rotary kiln 1 and is determined based on a set y₂ of measured process variables y including torque (Y_{Torque}) required to rotate the kiln 1, NOₓ measurements in the exhaust gas (Y_{NOx}), and temperature readings based on a pyrometer located at the exit opening (discharge or front end) of the kiln (Y_{Pyro}), as described earlier with reference to FIG. 1.

In another example, in a wet grinding process, the fuzzy indicator z indicates a mill state of a grinding system and is determined based on a set y₂ of measured process variables y including mill sound level, mill bearing pressure, mill power draw, slurry density, and flows and pressures at specific places, as described earlier with reference to FIG. 2.

FIG. 4 shows a block diagram illustrating an example of a control system according to an exemplary embodiment of the present disclosure for controlling an industrial process. In FIG. 4, reference numeral 4 denotes a control system according to an exemplary embodiment of the present disclosure for controlling an industrial process 42, such as a cement production process or a wet grinding process, for example. The industrial process 42 is controlled based on set-points of manipulated variables u, which are generated by process controller 41 based on the user defined set-points r.

The control system 4 further includes an indicator generator 43 for determining one or more fuzzy logic indicator(s) z based on a set y₂ of measured process variables y, and/or based on a set u₂ of the manipulated variables u, as described above in the context of FIG. 3. In accordance with an exemplary embodiment, the indicator generator 43 is based on a neural net system and/or a statistical learning method.

In control system 4, the process controller 41 can be implemented as a model based controller. Generally, in model based controllers (such as model predictive control, MPC) a mathematical model is used to predict the behavior of the system in the near future. This model can be a black-box or a physical model (i.e. grey-box) respectively. For control purposes, the model states should be provided before the controller generates the manipulated variables u. Specifically, MPC is a procedure of solving an optimal-control problem, which includes system dynamics and constraints on the system output and/or state variables. A system or process model valid at least around a certain operating point allows for expression of a manipulated system trajectory or sequence of output signals y in terms of a present state of the system, forecasts of external variables and future control signals u. A performance, cost or objective function involving the trajectory or output signals y is optimized according to some pre-specified criterion and over some prediction horizon. An optimum first or next control signal u₁ resulting from the optimization is then applied to the system, and based on the subsequently observed state of the system and updated external variables, the optimization procedure is repeated. Depending on the particular implementation, the model based controller 41 can be based on any linear or nonlinear model based control algorithm, such as IMC (Internal Model Control), LQR (Linear Quadratic Regulator), LQG (Linear Quadratic Gaussian), Linear MPC (Model Predictive Control), NMPC (Nonlinear Model Predictive Control), or the like.

The control system 4 includes comprises a state estimator 44 configured to determine the model states \hat{x}, e.g. as estimated physical process states, based on the fuzzy indicator z. As indicated schematically through dashed lines in FIG. 4, in accordance with different exemplary embodiments of the present disclosure, the state estimator 44 is configured to determine the model states (estimated physical process states) \hat{x} based also on a set y₁ of measured process variables y, and/or based on a set u₁ of the manipulated variables u. For example, the state estimator 44 is configured to derive the model states (estimated physical process states) \hat{x} by estimation techniques such as a Kalman filter, observer design or moving horizon estimation. EP 1406136 discloses an exemplary method of estimating model states or process properties. In a State Augmented Extended Kalman Filter (SAEKF) an augmented state p includes dynamic physical properties of the process which are representable by a function of the state vector x. In the example of the cement production process, the fuzzy logic indicator z provided by indicator generator 43 is the burning zone temperature Y_{BZT} of the rotary kiln 1, and the state estimator 44 is configured to determine the temperature profile 10 along the longitudinal axis of the kiln 1 based on the burning zone temperature Y_{BZT}. For that purpose, the state estimator 44 can include a suitable physical model of the kiln 1 which takes into account the mass flows and rotary speed of the kiln 1.

It should be noted that the sets u₁, u₂, yᵢ and y₂, are either 0, a subset of the parent set (u₁, ⊂u , yᵢ ⊂y), or the complete parent set, respectively.

As illustrated schematically in FIG. 4, in accordance with an exemplary embodiment of the present disclosure, there is an external, independent source 45, neither an actuator nor a measurement, providing an external input v₁ and/or v₂ to the indicator generator 43 and/or the state estimator 44, respectively. Correspondingly, the fuzzy logic indicator z is further based by the indicator generator 43 on external input v₁, and/or the model states \hat{x} are further based by the state estimator 44 on the external input v₂.

According to an exemplary embodiment, the process controller 41, indicator generator 43, and/or the state estimator 44 are logic modules implemented by a processor of a computing device executing programmed software modules recorded on a non-transitory computer-readable recording medium (e.g., ROM, hard disk drive, optical memory, flash memory, etc.). One skilled in the art will understand, however, that these logic modules can also be implemented fully or partly by hardware elements.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A control method for controlling an industrial process, the method comprising:
measuring a plurality of process variables;
determining at least one fuzzy logic based indicator from the measured process variables;
calculating, for controlling the process, manipulated variables based on defined set-points and the determined indicator;
determining estimated process states based on the indicator; and
calculating, by a controller, the manipulated variables based on a model of the process using the estimated process states.

2. The method according to claim 1, wherein:
the determining of the estimated process states includes determining estimated physical process states based on the indicator; and
the calculating of the manipulated variables includes calculating, by the controller, the manipulated variables based on a physical model of the process using the estimated physical process states.

3. The method according to claim 1, wherein:
the industrial process relates to operating a rotary kiln;
the measuring of the process variables includes measuring a torque required for rotating the kiln, measuring an NOx level in exhaust gas, and taking pyrometer readings at an exit opening of the kiln;
the determining of the indicator includes determining a burning zone temperature based on the torque, the NOx level, and the pyrometer readings;
the determining of the estimated process states includes determining a temperature profile along a longitudinal axis of the kiln based on the burning zone temperature; and
the manipulated variables are calculated based on the temperature profile.

4. The method according to claim 1, wherein the indicator is determined based on one or more of the manipulated variables.

5. The method according to claim 1, wherein the estimated process states are determined based on one or more of the process variables and/or one or more of the manipulated variables.

6. The method according to claim 1, wherein:
the manipulated variables are calculated by a Model Predictive Controller;
the estimated process states are determined by one of a Kalman filter, a state observer, and a moving horizon estimation method; and
the indicator is determined using one of a neural network and a statistical learning method.

7. A control system for controlling an industrial process, the system comprising:
sensors for measuring a plurality of process variables;
an indicator generator configured to determine at least one fuzzy logic based indicator from the measured process variables;
a process controller configured to calculate manipulated variables based on defined set-points and the determined indicator; and
an estimator configured to determine estimated process states based on the indicator,
wherein the process controller is configured to calculate the manipulated variables based on a model of the process using the estimated process states.

8. The system according to claim 7, wherein:
the estimator is configured to determine estimated physical process states based on the indicator; and
the process controller is configured to calculate the manipulated variables based on a physical model of the process using the estimated physical process states.

9. The system according to claim 7, wherein:
the industrial process relates to operating a rotary kiln;
the sensors are configured to measure, as process variables, a torque required for rotating the kiln, an NOx level in exhaust gas, and pyrometer readings at an exit opening of the kiln;
the indicator generator is configured to determine, as the indicator, a burning zone temperature based on the torque, the NOx level, and the pyrometer readings;
the estimator is configured to determine, as the estimated process states, a temperature profile along a longitudinal axis of the kiln based on the burning zone temperature; and
the process controller is configured to calculate the manipulated variables based on the temperature profile.

10. The system according to claim 7, wherein:
the indicator generator is connected to the process controller; and
the indicator generator is configured to determine the indicator based on one or more of the manipulated variables.

11. The system according to claim 7, wherein the estimator is connected to the process controller and/or one or more of the sensors; and
the estimator is configured to determine the estimated process states based on one or more of the process variables and/or one or more of the manipulated variables, respectively.

12. The system according to claim 7, wherein:
the process controller is a Model Predictive Controller;
the estimator includes one of a Kalman filter, a state observer, and a moving horizon estimation method; and
the indicator generator includes one of a neural network or a statistical learning method.

13. The method according to claim 2, wherein:
the industrial process relates to operating a rotary kiln;
the measuring of the process variables includes measuring a torque required for rotating the kiln, measuring a NOx level in exhaust gas, and taking pyrometer readings at an exit opening of the kiln;
the determining of the indicator includes determining a burning zone temperature based on the torque, an NOx level , and pyrometer readings;
the determining of the estimated process states includes determining a temperature profile along a longitudinal axis of the kiln based on the burning zone temperature; and
the manipulated variables are calculated based on the temperature profile.

14. The method according to claim 13, wherein the indicator is determined based on one or more of the manipulated variables.

15. The method according to claim 14, wherein the estimated process states are determined based on one or more of the process variables and/or one or more of the manipulated variables.

16. The method according to claim 15, wherein:
the manipulated variables are calculated by a Model Predictive Controller;
the estimated process states are determined by one of a Kalman filter, a state observer, and a moving horizon estimation method; and
the indicator is determined using one of a neural network and a statistical learning method.

17. The system according to claim 8, wherein:
the industrial process relates to operating a rotary kiln;
the sensors are configured to measure, as process variables, a torque required for rotating the kiln, an NOx level in exhaust gas, and pyrometer readings at an exit opening of the kiln;
the indicator generator is configured to determine, as the indicator, a burning zone temperature based on the torque, the NOx level, and the pyrometer readings;
the estimator is configured to determine, as the estimated process states, a temperature profile along a longitudinal axis of the kiln based on the burning zone temperature; and
the process controller is configured to calculate the manipulated variables based on the temperature profile.

18. The system according to claim 17, wherein:
the indicator generator is connected to the process controller; and
the indicator generator is configured to determine the indicator based on one or more of the manipulated variables.

19. The system according to claim 18, wherein the estimator is connected to the process controller and/or one or more of the sensors; and
the estimator is configured to determine the estimated process states based on one or more of the process variables and/or one or more of the manipulated variables, respectively.

20. The system according to claim 19, wherein:
the process controller is a Model Predictive Controller;
the estimator includes one of a Kalman filter, a state observer, and a moving horizon estimation method; and
the indicator generator includes one of a neural network or a statistical learning method.
